(19) United States
(12) Patent Application Publication
(10) Pub. No.: US 2026/0338568 A1
(43) Pub. Date: Oct. 29, 2026

(54) POSE DETERMINATION METHOD AND APPARATUS, AND ELECTRONIC DEVICE

(71) Applicants: ZHEJIANG GEELY HOLDING GROUP CO., LTD., Hangzhou (CN); GEELY AUTOMOBILE RESEARCH INSTITUTE (NINGBO) Co., LTD., Ningbo (CN)

(72) Inventors: Yongming WU, Hangzhou (CN); Jing ZHAO, Hangzhou (CN); Dian HUANG, Hangzhou (CN)

(73) Assignees: ZHEJIANG GEELY HOLDING GROUP CO., LTD., Hangzhou (CN); GEELY AUTOMOBILE RESEARCH INSTITUTE (NINGBO) Co., LTD., Ningbo (CN)

(21) Appl. No.: 19/698,799

(22) Filed: Jun. 4, 2026

Related U.S. Application Data
(63) Continuation-in-part of application No. PCT/CN2024/082022, filed on Mar. 15, 2024.

(30) Foreign Application Priority Data
Dec. 4, 2023 (CN) 202311649959.3

(51) Int. Cl. G01C 21/36; G06T 7/73

(52) U.S. Cl. CPC G01C 21/36; G06T 7/74

(57) ABSTRACT

A pose determination method, an electronic device, and a storage medium are provided. The method includes: acquiring a current first integration pose, first observation pose, and second observation pose of a vehicle; performing integration pose interpolation when an integration moment of the first integration pose is different from a target observation moment, to obtain a second integration pose having an integration moment identical to the target observation moment; determining a target pose correction matrix according to the first observation pose, the second observation pose, the second integration pose, and a current pose correction matrix; and obtaining a positioning pose of the vehicle based on the first integration pose and the target pose correction matrix.

### CROSS-REFERENCE TO RELATED APPLICATIONS

This application is a continuation in part of PCT Application No. PCT/CN2024/082022 filed on Mar. 15, 2024, which claims priority to Chinese Patent Application No. 202311649959.3, filed with the China National Intellectual Property Administration on Dec. 4, 2023, both of which are hereby incorporated by reference in their entireties.

### TECHNICAL FIELD

The present application relates to the technical field of autonomous driving, and in particular to a pose determination method and apparatus, and an electronic device.

### BACKGROUND

At present, for mainstream high-precision positioning in the field of autonomous driving, a multi-sensor fusion solution is adopted, which combines a global navigation satellite system (GNSS), inertial measurement units (IMUs), vision sensors, high-definition maps, and wheel speed sensors. Integration is performed by using the IMUs or the IMUs together with the wheel speed sensors, observation is performed by using the GNSS, the vision sensors, and the high-definition maps, and integration positioning is performed on the basis of observation correction.

### SUMMARY

The present application provides a pose determination method and apparatus, and an electronic device.

In a first aspect, the present application provides a pose determination method. The method includes:
acquiring a current first integration pose, first observation pose, and second observation pose of a vehicle;
performing integration pose interpolation when an integration moment of the first integration pose is different from a target observation moment, to obtain a second integration pose having an integration moment identical to the target observation moment, where the target observation moment is an observation moment that meets a preset requirement from a first observation moment of the first observation pose and a second observation moment of the second observation pose;
determining a target pose correction matrix according to the first observation pose, the second observation pose, the second integration pose, and a current pose correction matrix; and
obtaining a positioning pose of the vehicle based on the first integration pose and the target pose correction matrix.

In a possible design, performing the integration pose interpolation when the integration moment of the first integration pose is different from the target observation moment, to obtain the second integration pose having the integration moment identical to the target observation moment, includes: when the integration moment of the first integration pose is later than the target observation moment, performing the integration pose interpolation to obtain the second integration pose having the integration moment identical to the target observation moment; or when the integration moment of the first integration pose is earlier than the target observation moment, continuing to perform integration based on the first integration pose until the integration moment is greater than or equal to the target observation moment, and performing the integration pose interpolation to obtain the second integration pose having the integration moment identical to the target observation moment.

In a possible design, determining the target pose correction matrix according to the first observation pose, the second observation pose, the second integration pose, and the current pose correction matrix, includes: multiplying the second integration pose by the current pose correction matrix to obtain a predicted pose; filtering the predicted pose, the first observation pose, and the second observation pose to obtain a filtered pose; and calculating the target pose correction matrix based on the filtered pose and the second integration pose.

In a possible design, performing the integration pose interpolation, includes: searching for two frames of historical integration poses, where integration moments of the two frames of historical integration poses are a moment immediately before the target observation moment and a moment immediately after the target observation moment, respectively; and performing interpolation on the two frames of historical integration poses.

In a possible design, acquiring the current first integration pose, first observation pose, and second observation pose of the vehicle, includes: performing integration based on a wheel speed and an angular velocity of the vehicle, starting from an initial pose of the vehicle, to obtain the first integration pose, where the initial pose is a pose of the vehicle at startup; obtaining the first observation pose based on global navigation satellite system (GNSS) positioning data of the vehicle; and obtaining the second observation pose based on a visual sensor of the vehicle in combination with map data.

In a possible design, obtaining the first observation pose based on the GNSS positioning data of the vehicle, includes: determining whether an absolute value of a difference between a first relative pose and a second relative pose is less than a preset threshold, where the first relative pose is a relative pose between two adjacent frames of observation poses provided by raw GNSS positioning data, and the second relative pose is a relative pose between two frames of integration poses at moments corresponding to the two adjacent frames of observation poses; if the absolute value is less than the preset threshold, obtaining the first observation pose based on the raw GNSS positioning data; and if the absolute value is greater than or equal to the preset threshold, adjusting the first covariance of the raw GNSS positioning data to a first target covariance to obtain the GNSS positioning data, and obtaining the first observation pose based on the GNSS positioning data.

In a possible design, obtaining the second observation pose based on the visual sensor of the vehicle in combination with the map data, includes: collecting visual perception data based on the visual sensor, matching the visual perception data with the map data to obtain one or more matching pairs, and performing optimization processing on the one or more matching pairs to obtain a residual; determining whether the number of the one or more matching pairs is greater than or equal to a first set value, and whether the residual is less than or equal to a second set value; if the number of the one or more matching pairs is greater than or equal to the first set value and the residual is less than or equal to the second set value, not adjusting a second covariance, and obtaining the second observation pose based on the visual perception data, the map data, and the second covariance; and if the number of the one or more matching pairs is less than the first set value or the residual is greater than the second set value, adjusting the second covariance to a second target covariance, and obtaining the second observation pose based on the visual perception data, the map data, and the second target covariance.

In a second aspect, the present application provides a pose determination apparatus. The apparatus includes:
an acquisition module, configured to acquire a current first integration pose, first observation pose, and second observation pose of a vehicle;
an interpolation module, configured to perform integration pose interpolation when an integration moment of the first integration pose is different from a target observation moment, to obtain a second integration pose having an integration moment identical to the target observation moment, where the target observation moment is an observation moment that meets a preset requirement from a first observation moment of the first observation pose and a second observation moment of the second observation pose;
a determination module, configured to determine a target pose correction matrix according to the first observation pose, the second observation pose, the second integration pose, and a current pose correction matrix; and
a positioning module, configured to obtain a positioning pose of the vehicle based on the first integration pose and the target pose correction matrix.

In a possible design, the acquisition module is specifically configured to: perform integration based on a wheel speed and an angular velocity of the vehicle, starting from an initial pose of the vehicle, to obtain the first integration pose, where the initial pose is a pose of the vehicle at startup; obtain the first observation pose based on global navigation satellite system (GNSS) positioning data of the vehicle; and obtain the second observation pose based on a visual sensor of the vehicle in combination with map data.

In a possible design, the interpolation module is specifically configured to: when the integration moment of the first integration pose is later than the target observation moment, perform the integration pose interpolation to obtain the second integration pose having the integration moment identical to the target observation moment; or when the integration moment of the first integration pose is earlier than the target observation moment, continue to perform integration based on the first integration pose until the integration moment is greater than or equal to the target observation moment, and perform the integration pose interpolation to obtain the second integration pose having the integration moment identical to the target observation moment.

In a possible design, the determination module is specifically configured to: multiply the second integration pose by the current pose correction matrix to obtain a predicted pose; filter the predicted pose, the first observation pose, and the second observation pose to obtain a filtered pose; and calculate the target pose correction matrix based on the filtered pose and the second integration pose.

In a possible design, the interpolation module is further configured to: search for two frames of historical integration poses, where integration moments of the two frames of historical integration poses are a moment immediately before the target observation moment and a moment immediately after the target observation moment, respectively; and perform the interpolation on the two frames of historical integration poses.

In a possible design, the apparatus is further configured to: determine whether an absolute value of a difference between a first relative pose and a second relative pose is less than a preset threshold, where the first relative pose is a relative pose between two adjacent frames of observation poses provided by raw GNSS positioning data, and the second relative pose is a relative pose between two frames of integration poses at moments corresponding to the two adjacent frames of observation poses; if the absolute value is less than the preset threshold, obtain the first observation pose based on the raw GNSS positioning data; and if the absolute value is greater than or equal to the preset threshold, adjust the first covariance of the raw GNSS positioning data to a first target covariance to obtain the GNSS positioning data, and obtain the first observation pose based on the GNSS positioning data.

In a possible design, the apparatus is further configured to: collect visual perception data based on the visual sensor, match the visual perception data with the map data to obtain one or more matching pairs, and perform optimization processing on the one or more matching pairs to obtain a residual; determine whether the number of the one or more matching pairs is greater than or equal to a first set value, and whether the residual is less than or equal to a second set value; if the number of the one or more matching pairs is greater than or equal to the first set value and the residual is less than or equal to the second set value, not adjust a second covariance, and obtain the second observation pose based on the visual perception data, the map data, and the second covariance; and if the number of the one or more matching pairs is less than the first set value or the residual is greater than the second set value, adjust the second covariance to a second target covariance, and obtain the second observation pose based on the visual perception data, the map data, and the second target covariance.

In a third aspect, the present application provides an electronic device. The electronic device includes:
a memory, configured to store a computer program; and
one or more processors, configured to, when executing the computer program stored in the memory, implement the steps of the above pose determination method.

In a fourth aspect, the present application provides a computer readable storage medium. The computer readable storage medium stores a computer program. When the computer program is executed by one or more processors, the steps of the above pose determination method are implemented.

Various aspects from the second to the fourth aspects and the technical effects that can be achieved by the various aspects refer to description of the technical effects that can be achieved by the first aspect or various possible solutions in the first aspect, and will not be repeated here.

### BRIEF DESCRIPTION OF DRAWINGS

FIG. 1 is a schematic diagram of a pose determination method provided by the present application.

FIG. 2 is an algorithm description diagram of a pose determination method provided by the present application.

FIG. 3 is a schematic diagram of a pose determination apparatus provided by the present application.

FIG. 4 is a schematic structural diagram of an electronic device provided by the present application.

### DETAILED DESCRIPTION

In order to make objects, technical solutions and advantages of the present application clearer, the present application will be further described in detail below with reference to the accompanying drawings. The specific operation manner in the method embodiment may also be applied to the apparatus embodiment or the system embodiment.

In the description of the present application, “a plurality of” is understood as “at least two”. “And/or” describes an association relationship of association objects, and represents that there can be three types of relationships. For example, A and/or B can represent: existence of A alone, existence of both A and B, and existence of B alone. The connection between A and B may represent that A is directly connected to B, or A is connected to B via C. In addition, in the description of the present application, the terms, such as “first” and “second”, are merely used for a purpose of distinguishing descriptions, cannot be understood as indicating or implying relative importance, and cannot be understood as indicating or implying an order.

At present, for mainstream high-precision positioning in the field of autonomous driving, a multi-sensor fusion solution is adopted, which combines a GNSS, IMUs, vision sensors, high-definition maps, and wheel speed sensors. Integration is performed by using the IMUs or the IMUs together with the wheel speed sensors, observation is performed by using the GNSS, the vision sensors, and the high-definition maps, and integration positioning is performed on the basis of observation correction.

Because the GNSS and the visual sensor need a certain time when receiving signals, there is a situation that the observation pose generated by the GNSS or the observation pose generated by the visual sensor in combination with the high-definition map is earlier than the integration pose in time, and when the observation pose is earlier than the integration pose in time, front-back jumping or transverse jumping of the positioning pose may occur, which results in an unstable final positioning result.

To solve the above technical problem, the present application provides a pose determination method, to improve stability and precision of the positioning pose. The positioning pose is determined based on the pose determination method provided by the present application, which can provide data support for intelligent driving and/or assisted driving in a more stable and precise manner.

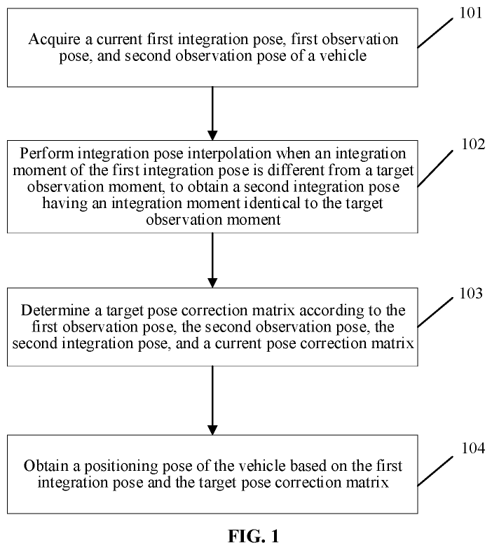

Referring to FIG. 1, FIG. 1 is a schematic flowchart of a pose determination method provided by an embodiment of the present application. The specific implementation process of the method includes the following steps 101-104.

At step 101, a current first integration pose, first observation pose, and second observation pose of a vehicle are acquired.

In the embodiment of the present application, the first integration pose is obtained by integrating a wheel speed and an angular velocity of the vehicle, the first observation pose is a pose provided by a global navigation satellite system (GNSS), and the second observation pose is a pose provided by a visual sensor of the vehicle in combination with map data.

It should be noted that the pose is represented by a letter T, where T is a 4×4 matrix, and the specific composition of the matrix is:

$$T = [ \begin{matrix}R & t \\ 0 & 1\end{matrix} ] ,$$

R is a 3×3 matrix, representing rotation from the body coordinate system to the world coordinate system, and tis a 3×1 vector, representing translation from the body coordinate system to the world coordinate system.

Specifically, the wheel speed is obtained by the wheel speed sensor, the angular velocity is provided by the inertial sensor IMU, and the initial pose of the vehicle at startup is provided by the GNSS. Based on the wheel speed and angular velocity of the vehicle, integration recursion is performed on the basis of the initial pose to obtain the first integration pose. The first integration pose may be represented by T^{I}, and the integration may be, but is not limited to, a midpoint integration. The specific integration process is integrating the wheel speed and the angular velocity to obtain a relative pose, and multiplying the relative pose by the initial pose of the vehicle to obtain the first integration pose T^{I}.

In the embodiment of the present application, the wheel speed and the angular velocity are acquired in real time, so the first integration pose T^{I} at each moment is obtained by continuously performing the integration according to the wheel speed and the angular velocity at each moment.

The first observation pose is provided by the GNSS positioning data of the vehicle, and may be represented by T^{G}. The GNSS positioning data may provide an observation pose with a first covariance. When filtering is performed, the first covariance of the observation pose participates in calculation of the filtering gain, thereby affecting the final output positioning pose. Therefore, the first covariance is adjusted as required, so that disturbance of the first covariance to the filtered pose may be reduced.

Specifically, two adjacent frames of observation poses are acquired through raw GNSS positioning data, and a first relative pose between the two adjacent frames of observation poses is calculated. The first relative pose may be represented as ΔT^{G}. Meanwhile, two adjacent frames of integration poses at moments corresponding to the two adjacent frames of observation poses are acquired, and a second relative pose between the two adjacent frames of integration poses is calculated. The second relative pose may be expressed as ATT.

For example, the observation pose T^{G}ₜ at the moment t and the observation pose T^{G}ₜ₊₁ at the moment t+1 are acquired through the raw GNSS positioning data, and the first relative pose ΔT^{G}=(T^{G}ₜ₊₁)⁻¹T^{G}ₜ is calculated; meanwhile, the integration pose T^{I}ₜ at the moment t and the integration pose T^{I}ₜ₊₁ at the moment t+1 are acquired, and the second relative pose ΔT^{I}=(T^{I}ₜ₊₁)⁻¹T^{I}ₜ is calculated.

An absolute value |(ΔT^{G})⁻¹ΔT^{I}| of a difference between the first relative pose and the second relative pose is calculated according to the first relative pose and the second relative pose, and it is determined whether the absolute value is less than a preset threshold. If the absolute value is less than the preset threshold, the first covariance of the raw GNSS positioning data is not adjusted, and the first observation pose is obtained based on the raw GNSS positioning data; and if the absolute value is greater than or equal to the preset threshold, it indicates that the observation pose provided by the raw GNSS positioning data has low precision and poor quality, the first covariance of the raw GNSS positioning data is adjusted to the first target covariance, and the first observation pose of the GNSS positioning data is obtained.

The second observation pose is obtained by the visual sensor of the vehicle in combination with the map data, and may be represented by T^{M}. Specifically, the visual sensor collects visual perception data, where element location information in the map is known. The visual perception data is matched with the map data to obtain one or more matching pairs, and optimization processing is performed on the one or more matching pairs to obtain a residual. The optimization may be a least squares optimization. The second covariance carried in the second observation pose is adjusted according to the one or more matching pairs and the residual. It is determined whether the number of the one or more matching pairs is greater than or equal to a first set value, and whether the residual is less than or equal to a second set value. If the number of the one or more matching pairs is greater than or equal to the first set value and the residual is less than or equal to the second set value, the second covariance is not adjusted, and the second observation pose is obtained based on the visual perception data, in combination with the map data and the second covariance. If the number of the one or more matching pairs is less than the first set value or the residual is greater than the second set value, the second covariance is adjusted to a second target covariance, and the second observation pose is obtained based on the visual perception data, in combination with the map data and the second target covariance.

At step 102, integration pose interpolation is performed when an integration moment of the first integration pose is different from a target observation moment, to obtain a second integration pose having an integration moment identical to the target observation moment.

In the embodiment of the present application, the target observation moment is an observation moment that meets a preset requirement from a first observation moment of the first observation pose and a second observation moment of the second observation pose. The preset requirement may be an observation moment with a minimum time value, that is, the observation moment with the minimum time value among the first observation moment and the second observation moment is used as the target observation moment. For example, the first observation moment of the first observation pose is the 1st s, the second observation moment of the second observation pose is the 2nd s, and the time value 1 of the first observation moment is less than the time value 2 of the second observation moment, so the first observation moment is used as the target observation moment.

Specifically, there are the following two situations that the integration moment of the first integration pose is different from the target observation moment.

In the first situation, the integration moment of the first integration pose is later than the target observation moment. For example, if the current first integration pose is the integration pose at the 3rd s, and the current observation pose is the observation pose at the 1st s, the integration moment of the current first integration pose is later than the target observation moment of the current observation pose.

In the second situation, the integration moment of the first integration pose is earlier than the target observation moment. For example, if the current first integration pose is the integration pose at the 2nd s, and the current observation pose is the observation pose at the 3rd s, the integration moment of the current first integration pose is earlier than the target observation moment of the current observation pose.

The integration moment of the first integration pose being later or earlier than the target observation moment depends on different transmission manners of data.

When the integration moment of the first integration pose is later than the target observation moment, two frames of historical integration poses, a moment immediately before the target observation moment and a moment immediately after the target observation moment in a time sequence, are searched for. For example, if the integration moment of the first integration pose is the 10th s, and the target observation moment is the 9.8th s, the historical integration pose at the 9.9th s and the historical integration pose at the 9.7th s are searched for. After two frames of historical integration poses are found, the interpolation is performed on the two frames of historical integration poses. The interpolation may be performing linear interpolation on the poses, or performing spherical linear interpolation on the poses. After performing the interpolation, a second integration pose having the integration moment identical to the target observation moment is obtained, and may be represented by T^{I′}.

When the integration moment of the first integration pose is earlier than the target observation moment, the integration continues to be performed based on the first integration pose until the integration moment is greater than or equal to the target observation moment. For example, if the integration moment of the first integration pose is the 9.8th s, and the target observation moment is the 10th s, the integration continues to be performed on the first integration pose until the integration moment is greater than or equal to the 10th s. Then, the two frames of historical integration poses, the moment immediately before the target observation moment and the moment immediately after the target observation moment in the time sequence, are searched for, and the interpolation is performed on the two frames of historical integration poses. The interpolation may be performing linear interpolation on the poses, or performing spherical linear interpolation on the poses. After performing the interpolation, the second integration pose T″ having the integration moment identical to the target observation moment is obtained. In an embodiment, if the integration moment of the first integration pose is the 9.8th s, and the target observation moment is the 10th s, the integration continues to be performed on the first integration pose, for example, an integration pose at the integration moment 9.9th s and an integration pose at the integration moment 10.1th s are obtained, and the interpolation may be performed on the two integration poses, to obtain the second integration pose having the integration moment identical to the target observation moment.

At step 103, a target pose correction matrix is determined according to the first observation pose, the second observation pose, the second integration pose, and a current pose correction matrix.

Because the integration moment of the current first integration pose is later than or earlier than the target observation moment, there is an unstable phenomenon of front-back jumping or transverse jumping of the positioning pose obtained based on the current first integration pose, first observation pose, and second observation pose. In view of this, in the embodiment of the present application, the pose correction matrix is introduced and the first integration pose at the integration moment later than or earlier than the target observation moment is corrected, so that the finally obtained positioning pose is stable and has relatively high precision.

In the embodiment of the present application, the initial pose correction matrix is a set matrix, and may be, but is not limited to, a standard matrix. The pose correction matrix is dynamically updated according to the first observation pose, the second observation pose, and the second integration pose.

Specifically, the second integration pose is multiplied by the current pose correction matrix to obtain a predicted pose, and the predicted pose, the first observation pose, and the second observation pose are input into a filter for filtering to obtain a filtered pose. The filter may be an EKF (extended kalman filter), an ESKF (error state kalman filter), or the like, and the filtered pose may be represented by T^{F}.

Based on the filtered pose T^{F} and the second integration pose T^{I′}, the target pose correction matrix is calculated, that is, the pose correction matrix is updated. The specific calculation formula is as follows:

ΔT−T^{F}(T^{I′})⁻¹;
ΔT is the target pose correction matrix, T^{F} is the filtered pose, and T^{I′} is the second integration pose.

At step 104, a positioning pose of the vehicle is obtained based on the first integration pose and the target pose correction matrix.

In the embodiment of the present application, after the target pose correction matrix ΔT is obtained, the positioning pose of the vehicle is obtained by using the first integration pose T^{I} and the target pose correction matrix ΔT. A specific formula for calculating the positioning pose is as follows:

T=ΔTT^{I};

T is the positioning pose, ΔT is the target pose correction matrix, that is, the pose correction matrix corresponding to the current first integration pose, and T^{I} is the current first integration pose.

In the embodiment of the present application, by using the pose correction matrix, no matter whether the observation pose is earlier than or later than the current first integration pose in time, it can be ensured that the finally obtained positioning pose does not jump, thereby improving stability and precision of the positioning result.

In some embodiments, the positioning pose is output by an output device in the vehicle to provide driving guidance for the driver. In some embodiments, the positioning pose may be output as a prompt. For example, the positioning pose is shown on a display screen in the vehicle in the form of text, or in the form of a graphical presentation with illustrations, such as displaying the distance between the vehicle and an obstacle on the right side in the display screen. In some embodiments, the positioning pose may be sent by an audio device to the driver in the form of voice output. In some embodiments, the output device may be a vehicle mounted device, such as a human-machine interaction device in the vehicle, or any other vehicle mounted device capable of sending the prompt about the positioning pose in the form of text or graphical presentation, or sending the prompt to the driver through the voice or sound.

In some embodiments, the positioning pose may be directly sent to the autonomous driving control system or assisted driving control system of the vehicle. Specifically, the positioning pose is converted into a control instruction identifiable by an executing mechanism of the vehicle, including but not limited to: a steering system, a braking system, a driving system, and an automatic transmission control system. The automatic driving control system or assisted driving control system of the vehicle automatically controls the vehicle to perform corresponding driving operations based on the control instruction, without the need for driver intervention. For example, when the positioning pose is “the vehicle head turning left at 3 degrees”, the steering system of the vehicle automatically turns left at 3 degrees.

In some embodiments, after the vehicle obtains the positioning pose, the vehicle may send the positioning pose to a server platform, so that the server platform performs an update on a pre-stored pose of the vehicle based on the obtained positioning pose to make the stored data more accurate.

In some embodiments, after the vehicle obtains the positioning pose, the vehicle may plan, based on the positioning pose and environment data, a path in which the vehicle is to travel and a speed in which the vehicle is to travel for a upcoming period of time, etc., to provide driving guidance for the intelligent driving and/or assisted driving in a more stable, safe, and precise manner.

For example, the vehicle plans a global optimal path based on its current location as a starting point, combined with a high-precision map and a destination; at the same time, the vehicle calculates the remaining mileage and the estimated arrival time from the destination based on real-time poses. For another example, if the environment data includes “a pedestrian appearing 100 meters ahead”, in order to avoid the pedestrian, the vehicle may plan a path to bypass the pedestrian (such as turning left for 100 meters at 1 degree) and slow down.

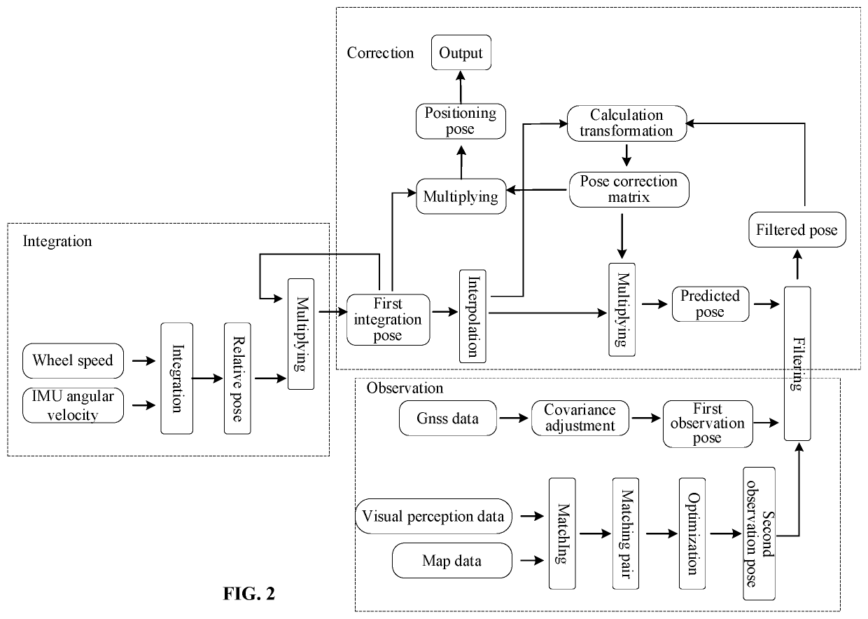

Referring to FIG. 2, FIG. 2 is an algorithm description diagram of a pose determination method provided by an embodiment of the present application. The algorithm is mainly applied to a scenario in which an observation moment of an observation pose is later than or earlier than an integration moment of an integration pose. As shown in FIG. 2, the algorithm may be divided into three portions: integration, observation, and correction.

The integration portion is a specific algorithm for determining the first integration pose.

Taking IMU+wheel speed integration as an example, the IMU provides an angular velocity, the GNSS provides an initial pose of the vehicle at startup, the integration is performed according to the angular velocity and the wheel speed to obtain a relative pose, and the first integration pose may be obtained by multiplying the relative pose by the initial pose. In the integration portion, as long as information of the angular velocity and the wheel speed is continuously received, the integration may be performed continuously to update the first integration pose.

The observation portion is a specific algorithm for determining an observation pose. Observation poses are divided into a first observation pose provided by the GNSS positioning data and a second observation pose provided by the visual perception data and map data.

When the first observation pose is provided based on the GNSS, the first covariance of the raw GNSS positioning data is adjusted according to the absolute value |(ΔT^{G})⁻¹ΔT^{I}| of the difference between the first relative pose ΔT^{G} of two adjacent frames of observation poses provided by the GNSS positioning data and the second relative pose ΔT^{I} of two frames of integration poses at corresponding moments. If the absolute value |(ΔT^{G})⁻¹ΔT^{I}| is less than the preset threshold, the first covariance of the raw GNSS positioning data is not adjusted, and the first observation pose is provided based on the raw GNSS positioning data; and if the absolute value | (ΔT^{G})⁻¹ΔT^{I}| is greater than or equal to the preset threshold, the first covariance of the raw GNSS positioning data is adjusted to the first target covariance, and the GNSS positioning data is obtained to provide the first observation pose.

When the second observation pose is provided based on the visual perception data and the map data, the visual perception data is matched with the map data to obtain one or more matching pairs, least square optimization is performed on the one or more matching pairs, to obtain an optimized residual, and the second covariance carried in the second observation pose is adjusted according to the one or more matching pairs and the residual. It is determined whether the number of the one or more matching pairs is greater than or equal to a first set value, and whether the residual is less than or equal to a second set value. If the number of the one or more matching pairs is greater than or equal to the first set value and the residual is less than or equal to the second set value, the second covariance is not adjusted, and the second observation pose is obtained based on the visual perception data, in combination with the map data and the second covariance. If the number of the one or more matching pairs is less than the first set value or the residual is greater than the second set value, the second covariance is adjusted to a second target covariance, and the second observation pose is obtained based on the visual perception data, in combination with the map data and the second target covariance. The first observation pose and the second observation pose are collectively referred to as observation poses.

The correction portion is an algorithm for determining the pose correction matrix.

When the observation pose is earlier than the current first integration pose in time, two frames of historical integration poses that are closest to the target observation moment before and after the target observation moment in the time sequence are searched for. The target observation moment is an observation moment with an earlier time value in the time sequence among a first observation moment corresponding to the first observation pose and a second observation moment corresponding to the second observation pose. After two frames of historical integration poses are found, the interpolation is performed on the two frames of historical integration poses. The interpolation may be performing linear interpolation on the poses, or performing spherical linear interpolation on the poses. After performing the interpolation, the second integration pose having the integration moment identical to the target observation moment is obtained.

When the observation pose is later than the current first integration pose in time, the integration continues to be performed based on the first integration pose until the integration moment is greater than or equal to the target observation moment, then two frames of historical integration poses that are closest to the target observation moment before and after the target observation moment in the time sequence are searched for, and the integration is performed on the two frames of historical integration poses. The interpolation may be performing linear interpolation on the poses, or performing spherical linear interpolation on the poses. After performing the interpolation, the second integration pose having the integration moment identical to the target observation moment is obtained.

The second integration pose is multiplied by the current pose correction matrix to obtain a predicted pose, and the predicted pose, the first observation pose, and the second observation pose are input into a filter for filtering to obtain a filtered pose. Then, an updated pose correction matrix is calculated based on the filtered pose T^{F} and the second integration pose T″, where a calculation formula is ΔT=T^{F} (T^{I′})⁻¹. The positioning pose T is calculated by using the first integration pose T^{I} and the latest pose correction matrix ΔT, where the calculation formula is: T=ΔT T^{I}.

Based on the algorithm of the pose determination method provided above, the positioning pose with high stability and high precision can be obtained, and it is ensured that the output positioning result does not jump.

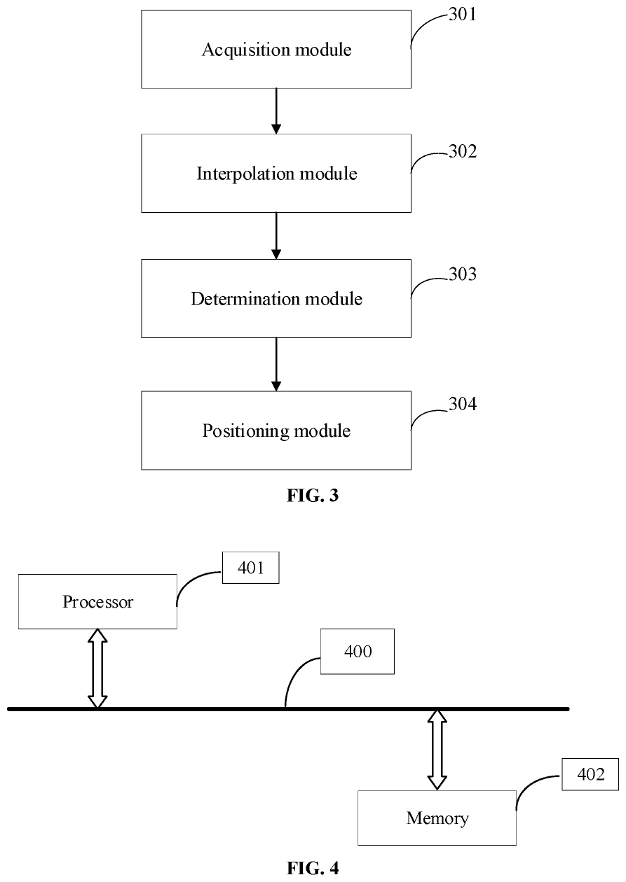

Based on the same inventive concept, the present application further provides a pose determination apparatus, to improve stability and precision of the positioning pose. Referring to FIG. 3, the apparatus includes:
an acquisition module 301, configured to acquire a current first integration pose, first observation pose, and second observation pose of a vehicle, where the first observation pose is a pose provided by a global navigation satellite system (GNSS), and the second observation pose is a pose provided by a visual sensor in combination with map data;
an interpolation module 302, configured to perform integration pose interpolation when an integration moment of the first integration pose is different from a target observation moment, to obtain a second integration pose having an integration moment identical to the target observation moment, where the target observation moment is an observation moment that meets a preset requirement from a first observation moment of the first observation pose and a second observation moment of the second observation pose;
a determination module 303, configured to determine a target pose correction matrix according to the first observation pose, the second observation pose, the second integration pose, and a current pose correction matrix; and
a positioning module 304, configured to obtain a positioning pose of the vehicle based on the first integration pose and the target pose correction matrix.

In a possible design, the acquisition module 301 is specifically configured to: perform integration based on a wheel speed and an angular velocity of the vehicle, starting from an initial pose of the vehicle, to obtain the first integration pose, where the initial pose is a pose of the vehicle at startup; obtain the first observation pose based on global navigation satellite system (GNSS) positioning data of the vehicle; and obtain the second observation pose based on a visual sensor of the vehicle in combination with map data.

In a possible design, the interpolation module 302 is specifically configured to: when the integration moment of the first integration pose is later than the target observation moment, perform the integration pose interpolation to obtain the second integration pose having the integration moment identical to the target observation moment; or when the integration moment of the first integration pose is earlier than the target observation moment, continue to perform integration based on the first integration pose until the integration moment is greater than or equal to the target observation moment, and perform the integration pose interpolation to obtain the second integration pose having the integration moment identical to the target observation moment.

In a possible design, the determination module 303 is specifically configured to: multiply the second integration pose by the current pose correction matrix to obtain a predicted pose; filter the predicted pose, the first observation pose, and the second observation pose to obtain a filtered pose; and calculate the target pose correction matrix based on the filtered pose and the second integration pose.

In a possible design, the interpolation module 302 is further configured to: search for two frames of historical integration poses, where integration moments of the two frames of historical integration poses are a moment immediately before the target observation moment and a moment immediately after the target observation moment, respectively; and perform the interpolation on the two frames of historical integration poses.

In a possible design, the apparatus is further configured to: determine whether an absolute value of a difference between a first relative pose and a second relative pose is less than a preset threshold, where the first relative pose is a relative pose between two adjacent frames of observation poses provided by raw GNSS positioning data, and the second relative pose is a relative pose between two frames of integration poses at moments corresponding to the two adjacent frames of observation poses; if the absolute value is less than the preset threshold, not adjust a first covariance of the raw GNSS positioning data, and obtain the first observation pose based on the raw GNSS positioning data; and if the absolute value is greater than or equal to the preset threshold, adjust the first covariance of the raw GNSS positioning data to a first target covariance to obtain the GNSS positioning data, and obtain the first observation pose based on the GNSS positioning data.

In a possible design, the apparatus is further configured to: capture visual perception data based on the visual sensor, match the visual perception data with the map data to obtain one or more matching pairs, and perform optimization processing on the one or more matching pairs to obtain a residual; determine whether the number of the one or more matching pairs is greater than or equal to a first set value, and whether the residual is less than or equal to a second set value; if the number of the one or more matching pairs is greater than or equal to the first set value and the residual is less than or equal to the second set value, not adjust a second covariance, and obtain the second observation pose based on the visual perception data, the map data, and the second covariance; and if the number of the one or more matching pairs is less than the first set value or the residual is greater than the second set value, adjust the second covariance to a second target covariance, and obtain the second observation pose based on the visual perception data, the map data, and the second target covariance.

Based on the same inventive concept, an embodiment of the present application further provides an electronic device. The electronic device may implement a function of the above pose determination apparatus. Referring to FIG. 4, the electronic device includes:
at least one processor 401 and a memory 402 connected to the at least one processor 401. A specific connection medium between the processor 401 and the memory 402 is not limited in the embodiment of the present application. In FIG. 4, the connection between the processor 401 and the memory 402 via a bus 400 is taken as an example. The bus 400 is represented by a thick line in FIG. 4, and connection manners between other components are merely for illustrative description, and are not limited thereto. The bus 400 may be classified into an address bus, a data bus, a control bus, and the like. For ease of representation, only one thick line is used to represent the bus 400 in FIG. 4, but this does not mean that there is only one bus or one type of bus. Alternatively, the processor 401 may also be referred to as a controller, and a name is not limited.

In the embodiment of the present application, the memory 402 stores instructions executable by the at least one processor 401, and the at least one processor 401 may perform the pose determination method described above by executing the instructions stored in the memory 402. The processor 401 may implement functions of various modules in the apparatus shown in FIG. 3.

The processor 401 is a control center of the apparatus, and may connect various parts of the entire control device by using various interfaces and lines, and perform overall monitoring on the apparatus by running or executing instructions stored in the memory 402 and invoking data stored in the memory 402, and various functions and processing data of the apparatus.

In a possible design, the processor 401 may include one or more processing units. The processor 401 may integrate an application processor and a modem processor. The application processor mainly processes an operating system, user interfaces, application programs, and the like, and the modem processor mainly processes wireless communication. It may be understood that the modem processor may not be integrated into the processor 401. In some embodiments, the processor 401 and the memory 402 may be implemented on a same chip. In some embodiments, the processor and the memory may also be separately implemented on separate chips.

The processor 401 may be a general-purpose processor, for example, a central processing unit (CPU), a digital signal processor, an application-specific integrated circuit, a field programmable gate array or another programmable logic device, a discrete gate or transistor logic device, or a discrete hardware component, and may implement or perform the method, steps, and logical block diagrams disclosed in the embodiments of the present application. The general-purpose processor may be a microprocessor or any conventional processor or the like. The steps of the pose determination method disclosed with reference to the embodiments of the present application may be directly performed by a hardware processor, or may be performed by using a combination of hardware and a software module in the processor.

As a non-volatile computer-readable storage medium, the memory 402 may be configured to store non-volatile software programs, non-volatile computer-executable programs, and modules. The memory 402 may include at least one type of storage medium, for example, may include a flash memory, a hard disk, a multimedia card, a card-type memory, a random access memory (RAM), a static random access memory (SRAM), a programmable read only memory (PROM), a read only memory (ROM), an electrically erasable programmable read-only memory (EEPROM), a magnetic memory, a magnetic disk, an optical disk, or the like. The memory 402 is any other medium capable of carrying or storing desired program codes in the form of instructions or data structures and capable of being accessed by a computer, but is not limited thereto. The memory 402 in the embodiment of the present application may alternatively be a circuit or any other apparatus that can implement a storage function, and is configured to store program instructions and/or data.

By designing and programming the processor 401, codes corresponding to the pose determination method described in the above embodiment may be solidified into the chip, so that the chip can perform the steps of the pose determination method in the embodiment shown in FIG. 1 when running. How to design and program the processor 401 is a technology known to those skilled in the art, and details are not described herein again.

Based on the same inventive concept, an embodiment of the present application further provides a storage medium. The storage medium stores computer instructions, and when the computer instructions run on a computer, the computer is enabled to perform the above pose determination method.

In some possible implementations, various aspects of the pose determination method provided in the present application may further be implemented in a form of a program product, including program codes. When the program product runs on the apparatus, the program codes are used to cause the control device to perform the steps of the pose determination method according to the various example implementations of the present application described above in this specification.

Those skilled in the art should understand that embodiments of the present application may be provided as a method, an apparatus, or a computer program product. Therefore, the present application may take the form of complete hardware embodiments, complete software embodiments, or embodiments combining software and hardware aspects. Furthermore, the present application may take the form of a computer program product that is implemented on one or more computer available storage medium (including but not limited to a magnetic disk memory, a CD-ROM, an optical memory, etc.) containing computer available program codes.

The present application is described with reference to the flow diagrams and/or the block diagrams of the method, device (system), and computer program product according to the embodiments of the present application. It should be understood that each flow and/or each block in the flow diagrams and/or the block diagrams and the combination of flows and/or blocks in the flow diagrams and/or the block diagrams may be realized by computer program instructions. These computer program instructions may be provided to a processor of a general-purpose computer, a special-purpose computer, an embedded processor, or other programmable data processing devices to generate a machine, such that the instructions executed by the processor of the computer or other programmable data processing devices generate an apparatus for implementing functions specified in one or more flows of the flow diagrams and/or one or more blocks of the block diagrams.

These computer program instructions may also be stored in a computer-readable memory that can guide a computer or other programmable data processing devices to work in a specific way, such that the instructions stored in the computer-readable memory generate a manufacturing product including an instruction apparatus. The instruction apparatus implements the functions specified in one or more flows of the flow diagrams and/or one or more blocks of the block diagrams.

These computer program instructions may also be loaded to a computer or other programmable data processing devices, such that a series of operation steps are performed on the computer or the other programmable electronic devices to generate computer-implemented processing. Therefore, the instructions executed on the computer or the other programmable devices provide steps for implementing the functions specified in one or more flows of the flow diagrams and/or one or more blocks of the block diagrams.

Obviously, those skilled in the art may make various modifications and variations to the present application without departing from the spirit and scope of the present application. Thus, if these modifications and variations to the present application fall within the scope of the claims of the present application and their equivalents, the present application is also intended to include these modifications and variations.

What is claimed is:

1. A pose determination method, comprising:
acquiring a current first integration pose, first observation pose, and second observation pose of a vehicle;
performing integration pose interpolation when an integration moment of the first integration pose is different from a target observation moment, to obtain a second integration pose having an integration moment identical to the target observation moment, wherein the target observation moment is an observation moment that meets a preset requirement from a first observation moment of the first observation pose and a second observation moment of the second observation pose;
determining a target pose correction matrix according to the first observation pose, the second observation pose, the second integration pose, and a current pose correction matrix; and
obtaining a positioning pose of the vehicle based on the first integration pose and the target pose correction matrix.

2. The method of claim 1, wherein performing the integration pose interpolation when the integration moment of the first integration pose is different from the target observation moment, to obtain the second integration pose having the integration moment identical to the target observation moment, comprises:
when the integration moment of the first integration pose is later than the target observation moment, performing the integration pose interpolation to obtain the second integration pose having the integration moment identical to the target observation moment; or
when the integration moment of the first integration pose is earlier than the target observation moment, continuing to perform integration based on the first integration pose until the integration moment is greater than or equal to the target observation moment, and performing the integration pose interpolation to obtain the second integration pose having the integration moment identical to the target observation moment.

3. The method of claim 1, wherein determining the target pose correction matrix according to the first observation pose, the second observation pose, the second integration pose, and the current pose correction matrix, comprises:
multiplying the second integration pose by the current pose correction matrix to obtain a predicted pose;
filtering the predicted pose, the first observation pose, and the second observation pose to obtain a filtered pose; and
calculating the target pose correction matrix based on the filtered pose and the second integration pose.

4. The method of claim 2, wherein performing the integration pose interpolation, comprises:
searching for two frames of historical integration poses, wherein integration moments of the two frames of historical integration poses are a moment immediately before the target observation moment and a moment immediately after the target observation moment, respectively; and
performing interpolation on the two frames of historical integration poses.

5. The method of claim 1, wherein acquiring the current first integration pose, first observation pose, and second observation pose of the vehicle, comprises:
performing integration based on a wheel speed and an angular velocity of the vehicle, starting from an initial pose of the vehicle, to obtain the first integration pose, wherein the initial pose is a pose of the vehicle at startup;
obtaining the first observation pose based on global navigation satellite system (GNSS) positioning data of the vehicle; and
obtaining the second observation pose based on a visual sensor of the vehicle in combination with map data.

6. The method of claim 5, wherein obtaining the first observation pose based on the GNSS positioning data of the vehicle, comprises:
determining whether an absolute value of a difference between a first relative pose and a second relative pose is less than a preset threshold, wherein the first relative pose is a relative pose between two adjacent frames of observation poses provided by raw GNSS positioning data, and the second relative pose is a relative pose between two frames of integration poses at moments corresponding to the two adjacent frames of observation poses;
if the absolute value is less than the preset threshold, not adjusting a first covariance of the raw GNSS positioning data, and obtaining the first observation pose based on the raw GNSS positioning data; and
if the absolute value is greater than or equal to the preset threshold, adjusting the first covariance of the raw GNSS positioning data to a first target covariance to obtain the GNSS positioning data, and obtaining the first observation pose based on the GNSS positioning data.

7. The method of claim 5, wherein obtaining the second observation pose based on the visual sensor of the vehicle in combination with the map data, comprises:
collecting visual perception data based on the visual sensor, matching the visual perception data with the map data to obtain one or more matching pairs, and performing optimization processing on the one or more matching pairs to obtain a residual;
determining whether a number of the one or more matching pairs is greater than or equal to a first set value, and whether the residual is less than or equal to a second set value;
if the number of the one or more matching pairs is greater than or equal to the first set value and the residual is less than or equal to the second set value, not adjusting a second covariance, and obtaining the second observation pose based on the visual perception data, the map data, and the second covariance; and
if the number of the one or more matching pairs is less than the first set value or the residual is greater than the second set value, adjusting the second covariance to a second target covariance, and obtaining the second observation pose based on the visual perception data, the map data, and the second target covariance.

8. The method of claim 1, further comprising:
sending the positioning pose to a driver via an output device, wherein the positioning pose is used to provide driving guidance for the driver.

9. The method of claim 1, further comprising:
converting the positioning pose into a control instruction identifiable by an executing mechanism of the vehicle, so that the vehicle automatically performs a corresponding driving operation according to the control instruction.

10. The method of claim 1, further comprising:
sending the positioning pose to a server platform, so that the server platform performs an update on a pre-stored pose of the vehicle based on the obtained positioning pose.

11. The method of claim 1, further comprising:
planning, based on the positioning pose and environment data, a path in which the vehicle is to travel and a speed in which the vehicle is to travel, to provide driving guidance for the vehicle.

12. An electronic device, comprising:
a memory, configured to store a computer program; and
one or more processors, configured to execute the computer program stored in the memory to:
acquire a current first integration pose, first observation pose, and second observation pose of a vehicle;
perform integration pose interpolation when an integration moment of the first integration pose is different from a target observation moment, to obtain a second integration pose having an integration moment identical to the target observation moment, wherein the target observation moment is an observation moment that meets a preset requirement from a first observation moment of the first observation pose and a second observation moment of the second observation pose;
determine a target pose correction matrix according to the first observation pose, the second observation pose, the second integration pose, and a current pose correction matrix; and
obtain a positioning pose of the vehicle based on the first integration pose and the target pose correction matrix.

13. The electronic device of claim 12, wherein the one or more processors are configured to:
when the integration moment of the first integration pose is later than the target observation moment, perform the integration pose interpolation to obtain the second integration pose having the integration moment identical to the target observation moment; or
when the integration moment of the first integration pose is earlier than the target observation moment, continue to perform integration based on the first integration pose until the integration moment is greater than or equal to the target observation moment, and perform the integration pose interpolation to obtain the second integration pose having the integration moment identical to the target observation moment.

14. The electronic device of claim 12, wherein the one or more processors are configured to:
multiply the second integration pose by the current pose correction matrix to obtain a predicted pose;
filter the predicted pose, the first observation pose, and the second observation pose to obtain a filtered pose; and
calculate the target pose correction matrix based on the filtered pose and the second integration pose.

15. The electronic device of claim 13, wherein the one or more processors are configured to:
search for two frames of historical integration poses, wherein integration moments of the two frames of historical integration poses are a moment immediately before the target observation moment and a moment immediately after the target observation moment, respectively; and
perform interpolation on the two frames of historical integration poses.

16. The electronic device of claim 12, wherein the one or more processors are configured to:
perform integration based on a wheel speed and an angular velocity of the vehicle, starting from an initial pose of the vehicle, to obtain the first integration pose, wherein the initial pose is a pose of the vehicle at startup;
obtain the first observation pose based on global navigation satellite system (GNSS) positioning data of the vehicle; and
obtain the second observation pose based on a visual sensor of the vehicle in combination with map data.

17. The electronic device of claim 16, wherein the one or more processors are configured to:
determine whether an absolute value of a difference between a first relative pose and a second relative pose is less than a preset threshold, wherein the first relative pose is a relative pose between two adjacent frames of observation poses provided by raw GNSS positioning data, and the second relative pose is a relative pose between two frames of integration poses at moments corresponding to the two adjacent frames of observation poses;
if the absolute value is less than the preset threshold, not adjust a first covariance of the raw GNSS positioning data, and obtain the first observation pose based on the raw GNSS positioning data; and
if the absolute value is greater than or equal to the preset threshold, adjust the first covariance of the raw GNSS positioning data to a first target covariance to obtain the GNSS positioning data, and obtain the first observation pose based on the GNSS positioning data.

18. The electronic device of claim 16, wherein the one or more processors are configured to:
collect visual perception data based on the visual sensor, matching the visual perception data with the map data to obtain one or more matching pairs, and perform optimization processing on the one or more matching pairs to obtain a residual;
determine whether a number of the one or more matching pairs is greater than or equal to a first set value, and whether the residual is less than or equal to a second set value;
if the number of the one or more matching pairs is greater than or equal to the first set value and the residual is less than or equal to the second set value, not adjust a second covariance, and obtain the second observation pose based on the visual perception data, the map data, and the second covariance; and
if the number of the one or more matching pairs is less than the first set value or the residual is greater than the second set value, adjust the second covariance to a second target covariance, and obtain the second observation pose based on the visual perception data, the map data, and the second target covariance.

19. A non-transitory computer readable storage medium, storing a computer program, wherein one or more processors execute the computer program to:
acquire a current first integration pose, first observation pose, and second observation pose of a vehicle;
perform integration pose interpolation when an integration moment of the first integration pose is different from a target observation moment, to obtain a second integration pose having an integration moment identical to the target observation moment, wherein the target observation moment is an observation moment that meets a preset requirement from a first observation moment of the first observation pose and a second observation moment of the second observation pose;
determine a target pose correction matrix according to the first observation pose, the second observation pose, the second integration pose, and a current pose correction matrix; and
obtain a positioning pose of the vehicle based on the first integration pose and the target pose correction matrix.

20. The storage medium of claim 19, wherein the one or more processors execute the computer program to:
when the integration moment of the first integration pose is later than the target observation moment, perform the integration pose interpolation to obtain the second integration pose having the integration moment identical to the target observation moment; or
when the integration moment of the first integration pose is earlier than the target observation moment, continue to perform integration based on the first integration pose until the integration moment is greater than or equal to the target observation moment, and perform the integration pose interpolation to obtain the second integration pose having the integration moment identical to the target observation moment.
